(19) United States
(12) Patent Application Publication
(10) Pub. No.: US 2005/0238784 A1
(43) Pub. Date: Oct. 27, 2005

(54) Soups comprising emulsified liquid shortening compositions comprising dietary fiber gel, water and lipid

(75) Inventors: Triveni Shukla, New Berlin, WI (US); Gregory Halpem, Vernon Hills, IL (US)

Correspondence Address: Circle Group Holdings, Inc., 1011 Campus Drive, Mundelein, IL, 60060, US

(73) Assignee: Circle Group Holdings, Inc.

(21) Appl. No.: 11/170,626

(22) Filed: Jun. 29, 2005

Related U.S. Application Data
(63) Continuation-in-part of application No. 10/689,274, filed on Oct. 20, 2003.

(51) Int. Cl. A23L 1/238

(52) U.S. Cl. 426/589

(57) ABSTRACT

According to the present invention, fat and caloric content of soups can be reduced by the replacement of a portion fat content normally found in soups with an equal amount of emulsified liquid shortening composition comprising dietary fiber gel, water and lipid. The result is that fat and caloric content of soups can be manipulated with minimal effect on taste and texture. Furthermore, these emulsified mixtures, or “emulsified liquid shortening compositions comprising dietary fiber gel, water and lipid”, can further comprise functional foods such as high omega three and omega six oils and pure omega three and omega six fatty acids, medium chain triglyceride, beta carotene, calcium estearate, vitamin E, bioflavonoids, fagopyritrol, polyphenolic antioxidants of vegetable origin, lycopene, luteine and soluble fiber, for example Beta-Glucan derived from yeast, and other soluble fibers derived from grain, flax seed, and other vegetable and fruit fiber sources, and any combination thereof. Hence, in addition to reducing fat and caloric content of soups, further health benefits can be achieved by replacing a portion of fat with emulsified liquid shortening compositions comprising dietary fiber gel, water and lipid.

### CROSS-REFERENCE TO RELATED APPLICATIONS

This application is a Continuation-in-Part Application of U.S. patent application Ser. No. 10/689274 filed on Oct. 20, 2003, the entirety of which is incorporated herein.

### TECHNICAL FIELD

The present invention relates generally to the field of food science and relates more specifically to soups comprising amorphous insoluble cellulosic fiber compositions.

### BACKGROUND OF THE INVENTION

The present invention relates to soups comprising emulsified liquid shortening compositions comprising amorphous insoluble cellulosic fiber gel, water and lipid. Recent media attention to the global problem of obesity demonstrates a need for greater availability of foods with low caloric and fat content. This is especially true for foods that often have high fat and caloric content, such as soups.

Soups typically comprise some fat. Other ingredients can vary according to the type of soup and the recipe followed, but often, soups are high in both fat and caloric content.

In recent years, some companies have begun to offer reduced fat soups. This variety of soup, however, often fails to retain the desirable taste and texture of soups comprising higher fat contents.

The absence of a means to reduce the fat and caloric content of soups while still producing a desirably flavored and textured soup presents an unmet need in today's food industry.

### DISCLOSURE OF THE INVENTION

It is an object of the present invention to provide a unique composition of matter embodied by low-calorie and low-fat soups. This reduction in caloric and fat content answers an unmet need in the food industry to provide the consuming public with a healthier, higher fiber alternative to traditional types of soups that typically are inherently fattening. It is another object of the present invention to provide soups that have been fortified with insoluble fiber and other functional foods.

Amorphous insoluble cellulosic fiber gels for calorie reduced foods hold the key to meeting this need. Amorphous insoluble cellulosic fiber gels for calorie reduced foods are fully described in U.S. Pat. No. 5,766,662 (the '662 patent), which is incorporated in its entirety herein. These amorphous insoluble cellulosic fiber gels comprise insoluble dietary fibers consisting of morphologically disintegrated cellular structures, and are characterized by their ability to retain large amounts of water. The amorphous insoluble cellulosic fiber gels are produced by shearing agricultural by-products, such as seed brans, hulls, and so forth, under alkaline conditions. Amorphous insoluble cellulosic fiber gels in a hydrated form can exits as gels, and in dehydrated form as flakes or powders. Additionally, these amorphous insoluble cellulosic fiber gels are characterized by their high viscosity at low solid levels. Other insoluble fibers derived from cereals, grains and legumes consist of morphologically intact cellular structures, and generally are of microcrystalline form; thus they impart a gritty texture to the foods in which they are contained. The amorphous insoluble cellulosic fiber gels disclosed in the '662 patent, however, are amorphous in nature and consist of morphologically disintegrated cellular structures; they thus impart a smoother texture than other insoluble fiber formulations. A physically smooth morphology is readily revealed under electron microscopic magnification of amorphous insoluble cellulosic fiber gel. The smooth morphology is also demonstrated by approximately 60 percent to 90 percent reduction in birefringence when compared to microcrystalline dietary fiber products. The smooth morphology reflects the amorphous nature of the insoluble compounds that constitute amorphous insoluble cellulosic fiber gel.

More specifically, the present invention utilizes emulsified mixtures of the amorphous insoluble cellulosic fiber gels disclosed in the '662 patent, the emulsified mixtures further comprising, at a minimum, water and lipid. These emulsified mixtures are fully described in and are the subject of U.S. patent application Ser. No. 10/669731, filed Sep. 24, 2003 which is herein incorporated by reference in its entirety. These emulsified mixtures, “emulsified liquid shortening compositions comprising dietary fiber gel, water and lipid”, can further comprise functional foods such as high omega three and omega six oils and pure omega three and omega six fatty acids, medium chain triglyceride, beta carotene, calcium estearate, vitamin E, bioflavonoids, fagopyritrol, polyphenolic antioxidants of vegetable origin, lycopene, luteine and soluble fiber, for example Beta-Glucan derived from yeast, and other soluble fibers derived from grain, flax seed, and other vegetable and fruit fiber sources, and any combination thereof. Hence, in addition to reducing fat and caloric content of soups, further health benefits can be achieved by replacing a portion of fat with emulsified liquid shortening compositions comprising dietary fiber gel, water and lipid.

According to the present invention, fat and caloric content can be reduced by the replacement of the fat normally found in soups with emulsified liquid shortening compositions comprising amorphous insoluble cellulosic fiber gel, water and lipid. This replacement of fat does not adversely affect either the taste or texture of the soups. The result is that fat and caloric content of soups can be manipulated with minimal effect on taste and texture, and as stated above, additional health benefits can be achieved through consumption of soups comprising emulsified liquid shortening compositions comprising amorphous insoluble cellulosic fiber gel, water and lipid when functional foods are included in the formulations.

Further objects, advantages and features of the present invention will present themselves in the following detailed description.

### BEST MODE FOR CARRYING OUT THE INVENTION

This invention is directed to soups comprising emulsified liquid shortening compositions comprising amorphous insoluble cellulosic fiber gel, water and lipid. According to the present invention, fat and caloric content can be reduced by the replacement of the fat normally found in soups with emulsified liquid shortening compositions comprising amorphous insoluble cellulosic fiber gel, water and lipid (hereinafter “emulsified liquid shortening”). This replacement of fat does not adversely affect either the taste or texture of the soups. The result is that fat and caloric content of soups can be manipulated with minimal effect on taste and texture.

Alternatively, the soups can be provided in the form of soup mixes and condensed soup concentrates with the intention that a consumer can mix them at a convenient, post-purchase time, and soup mixes and condensed soup concentrates are considered to be within the scope of this invention. As such, for purposes of this document, the term “soups” is defined to include soup mixes and condensed soup concentrates.

According to the present invention, soups can be formulated such that the soups comprise 0.25 percent to 5.00 percent dietary fiber gel solids by replacing an appropriate amount, that is, prorated to deliver this range of dietary fiber gel solids, of fat, including oil and liquid shortening, with an essentially identical amount of emulsified liquid shortening. The result is that fat and caloric content of soups can be manipulated with minimal effect on taste and texture, and as stated above, additional health benefits can be achieved through consumption of soups comprising emulsified liquid shortening compositions comprising amorphous insoluble cellulosic fiber gel, water and lipid when functional foods are included in the formulations.

### EXAMPLE 1

### Chicken Vegetable Soup Comprising Emulsified Liquid Shortening Compositions Comprising Dietary Fiber Gel, Water and Lipid

TABLE 1

| | Gram | Gram | |
|---|---|---|---|
| INGREDIENT | Without | With | Procedure |
| Chicken Breast boneless | 41.54 | 22.54 | Simmer chicken |
| Pealed and diced Carrots | 18.71 | 18.71 | for ten minutes. |
| Diced Celery Stalk | 10.38 | 10.38 | Shred and |
| Frozen Green Peas | 18.69 | 18.69 | return to soup. |
| Egg Noodles (% Fat, 4.00 | 10.38 | 7.38 | Blend and mix |
| Dried Thyme leaves | 0.30 | 0.30 | Emulsified Liquid |
| Emulsified Liquid | 0.00 | 2.50 | Shortening. Adjust |
| Shortening | | | herbs for |
| Water | | 19.5 | appropriate flavor. |
| Chicken Stock | 100.00 | 100.00 | |
| Total | 200.00 | 200.00 | |
| Percent Fat (Recipe) | 1.87 | 1.52 | |

Two formulations of Chicken Vegetable Soup are presented in Table 1. One soup formulation, labeled here as “Without”, represents a typical formulation for Chicken Vegetable Soup. A Chicken Vegetable Soup formulation, labeled here as “With” demonstrates a variation on the “Without” formulation and comprises Emulsified Liquid Shortening Compositions Comprising Dietary Fiber Gel, Water and Lipid. The formulation comprising Emulsified Liquid Shortening Compositions Comprising Dietary Fiber Gel, Water and Lipid exhibits a 19% reduction in fat compared to its counterpart formulation and comprises 0.30% (by weight) amorphous insoluble cellulosic fiber gel solids. Thus, in addition to eliminating 19% of the fat from a representative typical Chicken Vegetable Soup formulation, healthy dietary fiber has been added, making the “With” formulation a vehicle of delivery for insoluble dietary fiber.

### EXAMPLE 2

### Fish and Potato Soup Comprising Emulsified Liquid Shortening Compositions Comprising Dietary Fiber Gel, Water and Lipid

TABLE 2

| Ingredient | Gram | Gram | Procedure |
|---|---|---|---|
| Fleshed White Fish | 35.46 | 20.46 | Make a quick soup. |
| Thickly Shredded | 17.73 | 17.73 | Add parsley to fully cooked |
| Cabbage | | | soup. |
| Diced Celery Stalk | 8.86 | 8.86 | Blend in and mix well the |
| Diced Potatoes as | 35.46 | 32.96 | Emulsified Liquid Shortening |
| starch | | | |
| Bay leaves | 0.72 | 0.72 | |
| Minced Fresh Parsley | 1.77 | 1.77 | |
| Emulsified Liquid | 0.00 | 2.00 | |
| Shortening | | | |
| Chicken Stock | 100.00 | 100.00 | |
| Water | | 15.00 | |
| Total | 200.00 | 200.00 | |
| Percent Fat in Formula | 1.60 | 1.30 | |

Two formulations of Fish and Potato Soup are presented in Table 2. One soup formulation, labeled here as “Without”, represents a typical formulation for Fish and Potato Soup. A Fish and Potato Soup formulation, labeled here as “With” demonstrates a variation on the “Without” formulation and comprises Emulsified Liquid Shortening Compositions Comprising Dietary Fiber Gel, Water and Lipid. The formulation comprising Emulsified Liquid Shortening Compositions Comprising Dietary Fiber Gel, Water and Lipid exhibits a 19% reduction in fat compared to its counterpart formulation and comprises 0.24% (by weight) amorphous insoluble cellulosic fiber gel solids. Thus, in addition to eliminating 19% of the fat from a representative typical Fish and Potato Soup formulation, healthy dietary fiber has been added, making the “With” formulation a vehicle of delivery for insoluble dietary fiber.

### EXAMPLE 2

### Mushroom Soup Comprising Emulsified Liquid Shortening Compositions Comprising Dietary Fiber Gel, Water and Lipid

TABLE 3

| | Gram | Gram | |
|---|---|---|---|
| INGREDIENTS | Without | With | Procedure |
| Stage 1 | | | STAGE I: Emulsion |
| | | | Preparation: |
| Water | 14.00 | 14.00 | Mix and blend these ingredients and |
| Cream (30% Fat) | 1.85 | 0.50 | prepare an emulsion. See that whey |
| Vegetable oil | 1.75 | 0.75 | protein concentrate is fully hydrated. |
| Nonfat dry milk | 1.40 | 1.40 | |
| Whey Protein Concentrate(34%) | 0.60 | 0.60 | |
| Disodium Phosphate | 0.50 | 0.50 | |
| Stage 2 | | | |
| Water | 19.00 | 19.00 | Blanch Mushroom. |
| Diced Mushroom | 14.00 | 14.00 | Separate from the above, prepare a |
| Salt | 1.80 | 1.80 | blend of stage 2. |
| flavor Enhancer | 1.05 | 1.05 | |
| flavors | 0.40 | 0.40 | |
| Stage 3 | | | |
| Final Dilution with water | 22.75 | 25.10 | In 37.75 lb water, mix Z-trim and wheat |
| Water to slurry | 15.00 | 15.00 | flour for three minutes at high speed and |
| Emulsified Liquid Shortening | 0.00 | 2.50 | thus prepare a creamy z-Trim Gel. In |
| Wheat Flour | 1.00 | 1.00 | industrial operation a homogenization |
| Total | 100.00 | 100.00 | step will precede hot filling. |
| Percent Fat | 2.30 | 1.82 | |

Two formulations of Mushroom Soup are presented in Table 3. One soup formulation, labeled here as “Without”, represents a typical formulation for Mushroom Soup. A Mushroom Soup formulation, labeled here as “With” demonstrates a variation on the “Without” formulation and comprises Emulsified Liquid Shortening Compositions Comprising Dietary Fiber Gel, Water and Lipid. The formulation comprising Emulsified Liquid Shortening Compositions Comprising Dietary Fiber Gel, Water and Lipid exhibits a 21% reduction in fat compared to its counterpart formulation and comprises 0.60 % (by weight) amorphous insoluble cellulosic fiber gel solids. Thus, in addition to eliminating 21% of the fat from a representative typical Mushroom Soup formulation, healthy dietary fiber has been added, making the “With” formulation a vehicle of delivery for insoluble dietary fiber.

1. Soup, the soup having a formulation, the soup comprising emulsified liquid shortening composition comprising dietary fiber gel, water and lipid,
wherein the emulsified liquid shortening composition comprising dietary fiber gel, water and lipid is added in a prorated amount such that solids delivered by the dietary fiber gel represent 0.25 percent to 5.00 percent by weight of the overall soup formulation, and
the emulsified liquid shortening composition comprising dietary fiber gel, water and lipid replaces an equal amount of fat used in an otherwise identical recipe of soup that uses no emulsified liquid shortening compositions comprising dietary fiber gel, water and lipid.

2. Soup mix, the soup mix having a formulation when reconstituted, the mix comprising emulsified liquid shortening composition comprising dietary fiber gel, water and lipid,
wherein the emulsified liquid shortening composition comprising dietary fiber gel, water and lipid is added in a prorated amount such that solids contained within the dietary fiber gel represent 0.25 percent to 5.00 percent by weight of the overall soup mix formulation as reconstituted, and
the emulsified liquid shortening composition comprising dietary fiber gel, water and lipid replaces an equal amount of fat used in an otherwise identical recipe of soup mix that uses no emulsified liquid shortening compositions comprising dietary fiber gel, water and lipid.

3. Condensed soup concentrate, the condensed soup concentrate having a formulation when reconstituted, the condensed soup concentrate comprising emulsified liquid shortening composition comprising dietary fiber gel, water and lipid,
wherein the emulsified liquid shortening composition comprising dietary fiber gel, water and lipid is added in a prorated amount such that solids contained within the dietary fiber gel represent 0.25 percent to 5.00 percent by weight of the overall soup concentrate formulation as reconstituted, and
the emulsified liquid shortening composition comprising dietary fiber gel, water and lipid replaces an equal amount of fat used in an otherwise identical recipe of condensed soup concentrate that uses no emulsified liquid shortening compositions comprising dietary fiber gel, water and lipid.
